(19) United States
(12) Patent Application Publication
(10) Pub. No.: US 2014/0380080 A1
(43) Pub. Date: Dec. 25, 2014

(54) ENERGY-SAVING CIRCUIT FOR MOTHERBOARD

(71) Applicant: Hon Hai Precision Industry Co., Ltd., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 13/947,743

(22) Filed: Jul. 22, 2013

(30) Foreign Application Priority Data
Jun. 25, 2013 (TW) 102122605

(51) Int. Cl. G06F 1/32

(52) U.S. Cl. CPC G06F 1/3296
USPC 713/340

(57) ABSTRACT

An energy-saving circuit for a motherboard includes a connecting circuit, a control circuit, a power circuit, an audio circuit, and a south bridge circuit. The connecting circuit can be connected to a number of audio devices, or may be unconnected to an audio device. A first detecting signal to the control circuit is output by the connecting circuit when an audio device is connected, and a second detecting signal is output by the connecting circuit when no audio device is connected. The power circuit powers the audio circuit according to the first control signal, and provides no power according to the second control signal. The south bridge chip allows audio communication for the first control signal, and prevents audio communication for the second control signal.

### BACKGROUND

1. Technical Field

The present disclosure relates to energy-saving circuits, and particularly to an energy-saving circuit for a motherboard.

2.Description of Related Art

Many high-power chips, such as an audio chip arranged on the motherboard, will consume electrical energy even when the audio chip is not being used, which is a waste of energy. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an embodiment of an energy-saving circuit for a motherboard.

FIGS. 2 and 3 are circuit diagrams constituting the energy-saving circuit of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

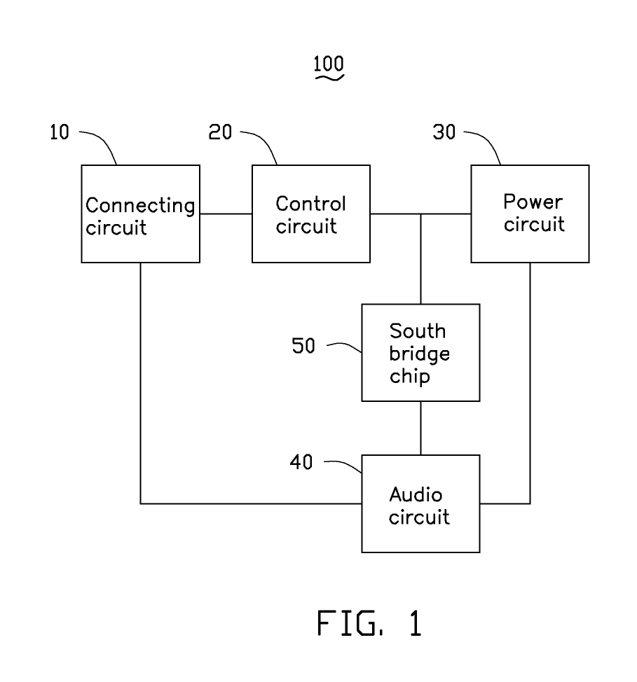

FIG. 1 shows an embodiment of an energy-saving circuit 100. The energy-saving circuit 100 is arranged on a motherboard and includes a connecting circuit 10, a control circuit 20, a power circuit 30, an audio circuit 40, and a south bridge chip 50. The connecting circuit 10 is connected to a plurality of audio devices, such as an earphone, a microphone, or a Moving Picture Experts Group audio layer III (MP3) device. The connecting circuit 10 outputs a first detecting signal (such as a digital-high signal) to the control circuit 20 when the connecting circuit 10 is not connected to any audio device, or the connecting circuit 10 will output a second detecting signal (such as a digital-low signal) to the control circuit 20 when the connecting circuit 10 is connected to at least one audio device. The control circuit 20 outputs a first control signal to the power circuit 30 and the south bridge chip 50 according to the first detecting signal. The power circuit 30 provides a voltage to the audio circuit 40 when the power circuit 30 receives the first control signal. The south bridge chip 50 controls the audio circuit 40 to communicate with the audio device which is connected to the connecting circuit 10, when the south bridge chip 50 receives the first control signal. The control circuit 20 outputs a second control signal to the power circuit 30 and the south bridge chip 50 according to the second detecting signal. When the power circuit 30 receives the second control signal, the power circuit 30 does not provide a voltage to the audio circuit 40. The south bridge chip 50 controls the audio circuit 40 to not operate when the south bridge chip 50 receives the second control signal.

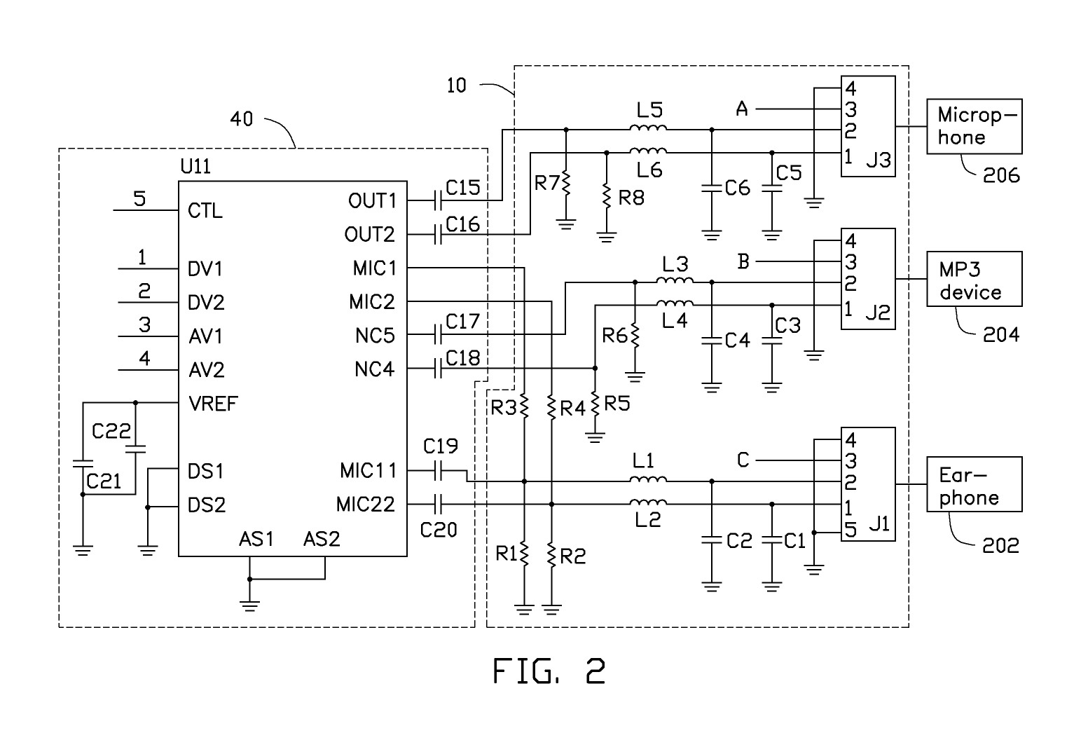

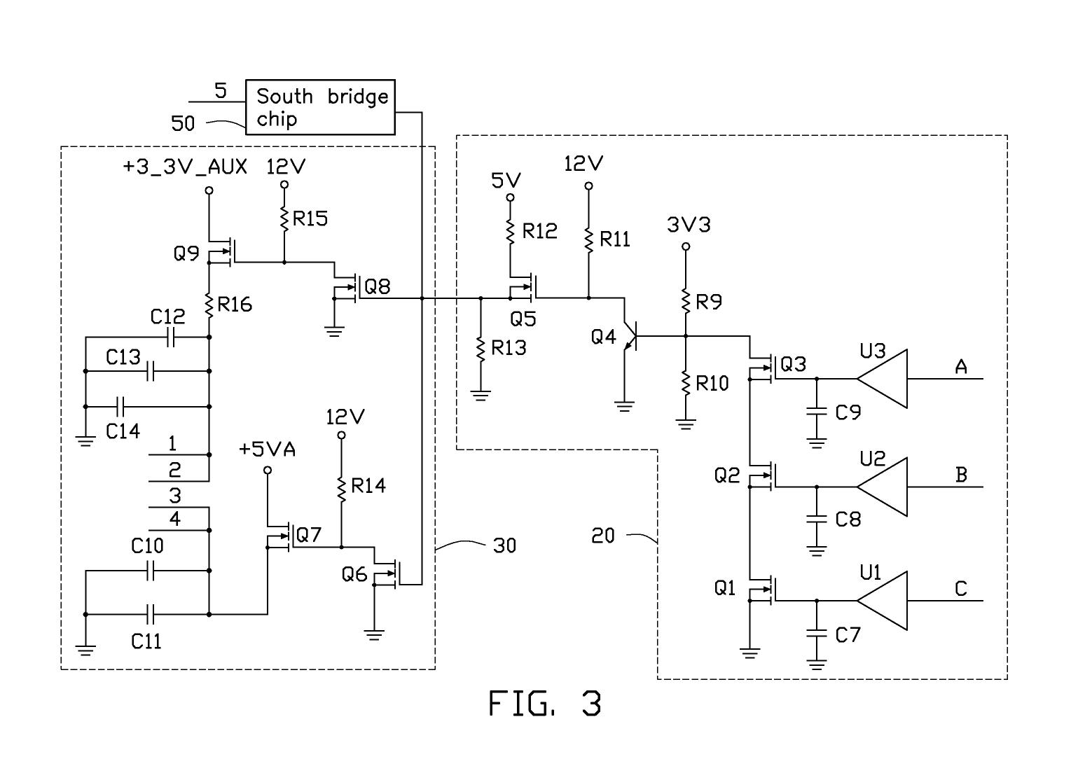

Referring to FIGS. 2 and 3, the connecting circuit 10 includes connectors J1-J3, capacitors C1-C6, inductors L1-L6, and resistors R1-R8. In one embodiment, the connectors J1-J3 are respectively connected to an earphone 202, an MP3 device 204, and a microphone 206. Pin 1 of the connector J1 is grounded through the inductor L2 and the resistor R2, connected in series. A node between the inductor L2 and the resistor R2 is connected to the audio circuit 40 and a first end of the resistor R4. A second end of the resistor R4 is connected to the audio circuit 40. Pin 2 of the connector J1 is grounded through the inductor L1 and the resistor R1, connected in series. A node between the inductor L1 and the resistor R1 is connected to the audio circuit 40 and a first end of the resistor R3. A second end of the resistor R3 is connected to the audio circuit 40. The capacitor C1 is connected between the pin 1 of the connector J1 and ground. The capacitor C2 is connected between the pin 2 of the connector J1 and ground. Pin 3 of the connector J1 is connected to the control circuit 20. Pins 4 and 5 of the connector J1 are grounded.

Pin 1 of the connector J2 is grounded through the inductor L4 and the resistor R5, connected in series. A node between the inductor L4 and the resistor R5 is connected to the audio circuit 40. Pin 2 of the connector J2 is grounded through the inductor L3 and the resistor R6, connected in series. A node between the inductor L3 and the resistor R6 is connected to the audio circuit 40. Pin 3 of the connector J2 is connected to the control circuit 20. Pin 4 of the connector J2 is grounded. The capacitor C3 is connected between the pin 1 of the connector J2 and ground. The capacitor C4 is connected between the pin 2 of the connector J2 and ground.

Pin 1 of the connector J3 is grounded through the inductor L6 and the resistor R8, connected in series. A node between the inductor L6 and the resistor R8 is connected to the audio circuit 40. Pin 2 of the connector J3 is grounded through the inductor L5 and the resistor R7 connected in series. A node between the inductor L5 and the resistor R7 is connected to the audio circuit 40. Pin 3 of the connector J2 is connected to the control circuit 20. Pin 4 of the connector J2 is grounded. The capacitor C5 is connected between the pin 1 of the connector J3 and ground. The capacitor C6 is connected between the pin 2 of the connector J3 and ground.

The control circuit 20 includes buffers U1-U3, capacitors C7-C9, resistors R9-R13, and five electronic switches Q1-Q5. In the embodiment, the electronic switches Q1-Q3 and Q5 are n-channel field effect transistors (FETs), and the electronic switch Q4 is an npn transistor Q4. An input terminal of the buffer U1 is connected to the pin 3 of the connector J1. An output terminal of the buffer U1 is grounded through the capacitor C7 and is also connected to a gate of the FET Q1. A source of the FET Q1 is grounded. A drain of the FET Q1 is connected to a source of the FET Q2. A gate of the FET Q2 is connected to an output terminal of the buffer U2 and also grounded through the capacitor C8. An input terminal of the buffer U2 is connected to the pin 3 of the connector J2. A drain of the FET Q2 is connected to a source of the FET Q3. A gate of the FET Q3 is connected to an output terminal of the buffer U3 and also grounded through the capacitor C9. An input terminal of the buffer U3 is connected to the pin 3 of the connector J3. A drain of the FET Q3 is connected to a base of the transistor Q4. The base of the transistor Q4 is grounded through the resistor R10 and also connected to a power source 3V3 through the resistor R9. An emitter of the transistor Q4 is grounded. A collector of the transistor Q4 is connected to a gate of the FET Q5 and also connected to a power source 12V through the resistor R11. A drain of the FET Q5 is connected to a power source 5V through the resistor R12. A source of the FET Q5 is connected to the power circuit 30 and also grounded through the resistor R13. The source of the FET Q5 is also connected to an input terminal of the south bridge chip 50. An output terminal of the south bridge chip 50 is connected to the audio circuit 40.

The power circuit 30 includes four electronic switches Q6-Q9, resistors R14-R16, and capacitors C10-C14. In the embodiment, the electronic switches Q6-Q9 are n-channel FETs. A gate of the FET Q6 is connected to the source of the FET Q5. A source of the FET Q6 is grounded. A drain of the FET Q6 is connected to a gate of the FET Q7 and also connected to the power source 12V through the resistor R14. A drain of the FET Q7 is connected to a power source +5VA. A source of the FET Q7 is connected to the audio circuit 40. The capacitor C10 is connected between the source of the FET Q7 and ground. The capacitor C11 is connected to the capacitor C10 in parallel. A gate of the FET Q8 is connected to the source of the FET Q5. A source of the FET Q8 is grounded. A drain of the FET Q8 is connected to a gate of the FET Q9 and also connected to the power source 12V through the resistor R15. A drain of the FET Q9 is connected to a power source +3_{—}3V AUX. A source of the FET Q9 is connected to a first end of the resistor R16. A second end of the resistor R16 is connected to the audio circuit 40. The capacitor C12 is connected between the second end of the resistor R16 and ground. The capacitors C13 and C14 are connected to the capacitor C12 in parallel.

The audio circuit 40 includes an audio chip U11 and capacitors C15-C22. A control pin CTL of the audio chip U11 is connected to the output terminal of the south bridge chip 50. Voltage pins DV1 and DV2 of the audio chip U11 are connected to the second end of the resistor R16. Voltage pins AV1 and AV2 of the audio chip U11 are connected to the source of the FET Q7. An input output (I/O) pin OUT1 of the audio chip U11 is connected to a node between the inductor L5 and the resistor R7 through the capacitor C15. An I/O pin OUT2 of the audio chip U11 is connected to a node between the inductor L6 and the resistor R8 through the capacitor C16. I/O pins MIC1 and MIC2 of the audio chip U11 are respectively connected to the second ends of the resistors R3 and R4. An I/O pin NC5 of the audio chip U11 is connected to a node between the inductor L3 and the resistor R6 through the capacitor C17. An I/O pin NC4 of the audio chip U1 is connected to a node between the inductor L4 and the resistor R5 through the capacitor C18. An I/O pin MIC11 of the audio chip U11 is connected to the first end of the resistor R3 through the capacitor C19. An I/O pin MIC22 of the audio chip U11 is connected to the first end of the resistor R4 through the capacitor C20. Ground pins DS1, DS2, AS1, and AS2 of the audio chip U11 connect to ground. A ground pin VREF of the audio chip U11 is grounded through the capacitor C21. The capacitor C22 is connected to the capacitor C21 in parallel.

In use, because pins of the audio devices corresponding to the pins 3 of the connectors J1-J3 are grounded, when the connectors J1-J3 are connected to the audio devices, the pins 3 of the connectors J1-J3 output low level signals. When the connectors J1-J3 are not connected to the audio devices, the pins 3 of the connectors J1-J3 output high level signals.

When the connectors J1-J3 are connected to the audio devices, the FETs Q1-Q3 are turned off. When the connector J1 is not connected to the audio device, and the connectors J2 and J3 are connected to the audio devices, the FET Q1 is turned on, and the FETs Q2 and Q3 are turned off. When the connector J2 is not connected to the audio device, and the connectors J1 and J3 are connected to the audio devices, the FETs Q1-Q3 are turned off. When the connectors J1 and J2 are not connected to the audio devices, and the connector J3 is connected to the audio device, the FETs Q1 and Q2 are turned on, and the FET Q3 is turned off. When the connectors J1 and J2 are connected to the audio devices, and the connector J3 is not connected to the audio device, the FETs Q1-Q3 are turned off. When the connectors J1 and J3 are not connected to the audio devices, and the connector J2 is connected to an audio device, the FET Q1 is turned on, and the FETs Q2 and Q3 are turned off. When the connector J1 is connected to an audio device, and the connectors J2 and J3 are not connected to audio devices, the FETs Q1-Q3 are turned off. Accordingly, the FET Q4 always receives a high level signal and is turned on. The FET Q5 always receives a low level signal and is turned off. The gates of the FETs Q6 and Q8 are at low level through the resistor R13. The FETs Q6 and Q8 are turned off. The FETs Q7 and Q9 are turned on. The audio chip U11 receives voltages from the power source +5VA and +3_{—}3V AUX through the voltage pins DV1, DV2, AV1, and AV2. At the same time, the input terminal of the south bridge chip 50 receives low level signals from the gates of the FETs Q6 and Q8 and controls the audio chip U11 to communicate with the audio devices, which are connected to the connectors J1-J3. Essentially, when at least one of the connectors J1-J3 is connected to an audio device, the audio chip U11 operates to enable communication with the audio device.

When the connectors J1-J3 are not connected to any audio devices, the FETs Q1-Q3 are turned on, the FET Q4 receives a low level signal from the drain of the FET Q3 and is turned off. The FET Q5 is turned on. The gates of the FETs Q6 and Q8 receive high level signals from the power source 5V through the FET Q5 and are turned on. The FETs Q7 and Q9 are turned off. The audio chip U11 does not receive any voltage through the voltage pins DV1, DV2, AV1, and AV2. At the same time, the input terminal of the south bridge chip 50 receives the high level signal from the gates of the FETs Q6 and Q8 and controls the audio chip U11 to not operate. Essentially, when the connectors J1-J3 are not connected to any audio devices, the audio chip U11 does not operate, and thus energy saving is realized.

The energy-saving circuit 100 receives detecting signals from the connectors J1-J3 through the control circuit 20 and outputs control signals to the power circuit 30 and the south bridge chip 50, to make the audio chip U11 operate when one of the connectors J1-J3 is connected to an audio device, or to make the audio chip U11 not operate when the connectors J1-J3 are not connected to any audio devices.

The foregoing description of the embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. An energy-saving circuit comprising:
a connecting circuit for connecting a plurality of audio devices, wherein the connecting circuit outputs a first detecting signal when the connecting circuit is connected to at least one of the audio devices, or the connecting circuit outputs a second detecting signal when the connecting circuit is not connected to the audio devices;
a control circuit to receive the first or second detecting signal from the connecting circuit, wherein the control circuit outputs a first control signal when the control circuit receives the first detecting signal, or the control circuit outputs a second control signal when the control circuit receives the second detecting signal;
an audio circuit;
a power circuit to receive the first or second control signal, wherein the power circuit provides a voltage to the audio circuit when the power circuit receives the first control signal, or the power circuit does not provide a voltage to the audio circuit when the power circuit receives the second control signal; and
a south bridge chip to receive the first or second control signal, wherein the south bridge chip controls the audio circuit to communicate with the audio device which is connected to the connecting circuit, when the south bridge chip receives the first control signal, or the south bridge chip controls the audio circuit to not operate when the south bridge chip receives the second control signal.

2. The energy-saving circuit of claim 1, wherein the connecting circuit comprises first to third connectors, first to sixth capacitors, first to sixth inductors, and first to eighth resistors, a first pin of the first connector is grounded through the second inductor and the second resistor connected in series, a node between the second inductor and the second resistor is connected to the audio circuit and a first end of the fourth resistor, a second end of the fourth resistor is connected to the audio circuit, a second pin of the first connector is grounded through the first inductor and the first resistor connected in series, a node between the first inductor and the first resistor is connected to the audio circuit and a first end of the third resistor, a second end of the third resistor is connected to the audio circuit, the first capacitor is connected between the first pin of the first connector and ground, the second capacitor is connected between the second pin of the first connector and ground, a third pin of the first connector is connected to the control circuit, fourth and fifth pins of the first connector are grounded; a first pin of the second connector is grounded through the third inductor and the fifth resistor connected in series, a node between the third inductor and the fifth resistor is connected to the audio circuit, a second pin of the second connector is grounded through the fourth inductor and the sixth resistor connected in series, a node between the fourth inductor and the sixth resistor is connected to the audio circuit, a third pin of the second connector is connected to the control circuit, a fourth pin of the second connector is grounded, the third capacitor is connected between the first pin of the second connector and ground, the fourth capacitor is connected between the second pin of the second connector and ground; a first pin of the third connector is grounded through the sixth inductor and the eighth resistor connected in series, a node between the sixth inductor and the eighth resistor is connected to the audio circuit, a second pin of the third connector is grounded through the fifth inductor and the seventh resistor connected in series, a node between the fifth inductor and the seventh resistor is connected to the audio circuit, a third pin of the third connector is connected to the control circuit, a fourth pin of the third connector is grounded, the fifth capacitor is connected between the first pin of the third connector and ground, the sixth capacitor is connected between the second pin of the third connector and ground.

3. The energy-saving circuit of claim 2, wherein the first to third connectors are respectively connected to an earphone, a Moving Picture Experts Group audio layer III (MP3) device, and a microphone.

4. The energy-saving circuit of claim 2, wherein the control circuit comprises first to third buffers, seventh to ninth capacitors, ninth to thirteen resistors, and first to fifth electronic switches, an input terminal of the first buffer is connected to the third pin of the first connector, an output terminal of the first buffer is grounded through the seventh capacitor and also connected to a first terminal of the first electronic switch, a second terminal of the first electronic switch is grounded, a third terminal of the first electronic switch is connected to a second terminal of the second electronic switch, a first terminal of the second electronic switch is connected to an output terminal of the second buffer and also grounded through the eighth capacitor, an input terminal of the second buffer is connected to the third pin of the second connector, a third terminal of the second electronic switch is connected to a second terminal of the third electronic switch, a first terminal of the third electronic switch is connected to an output terminal of the third buffer and also grounded through the ninth capacitor, an input terminal of the third buffer is connected to the third pin of the third connector, a third terminal of the third electronic switch is connected to a first terminal of the fourth electronic switch, the first terminal of the fourth electronic switch is grounded through the tenth resistor and also connected to a first power source through the ninth resistor, a second terminal of the fourth electronic switch is grounded, a third terminal of the fourth electronic switch is connected to a first terminal of the fifth electronic switch and also connected to a second power source through the eleventh resistor, a third terminal of the fifth electronic switch is connected to a third power source through the twelfth resistor, a second terminal of the fifth electronic witch is connected to the power circuit and also grounded through the thirteenth resistor, a second terminal of the fifth electronic witch is also connected to the input terminal of the south bridge chip, an output terminal of the south bridge chip is connected to the audio circuit.

5. The energy-saving circuit of claim 4, wherein the first to third electronic switches and the fifth electronic switch are n-channel field effect transistors (FETs), the first to third terminals of the first to third electronic switches and the fifth electronic switch are corresponding to gates, sources, and drains of the FETs, the fourth electronic switch is an npn transistor, the first to third terminals of the fourth electronic switch are corresponding to a base, a collector, and an emitter of the transistor.

6. The energy-saving circuit of claim 4, wherein the power circuit comprises sixth to ninth electronic switches, fourteenth to sixteenth resistors, and tenth to fourteenth capacitors, a first terminal of the sixth electronic switch is connected to a second terminal of the fifth electronic switch, a second terminal of the sixth electronic switch is grounded, a third terminal of the sixth electronic switch is connected to a first terminal of the seventh electronic switch and also connected to the second power source through the fourteenth resistor, a third terminal of the seventh electronic switch is connected to a fourth power source, a second terminal of the seventh electronic switch is connected to the audio circuit, the tenth capacitor is connected between the second terminal of the seventh electronic switch and ground, the eleventh capacitor is connected to the tenth capacitor in parallel, a first terminal of the eighth electronic switch is connected to the second terminal of the fifth electronic switch, a second terminal of the eighth electronic switch is grounded, a third terminal of the eighth electronic switch is connected to the first terminal of the ninth electronic switch and also connected to the second power source through the fifteenth resistor, a third terminal of the ninth electronic switch is connected to a fifth power source, a second terminal of the ninth electronic switch is connected to a first end of the sixteenth resistor, a second end of the sixteenth resistor is connected to the audio circuit, the twelfth capacitor is connected between the second end of the sixteenth resistor and ground, the fourteenth capacitor is connected to the twelfth capacitor in parallel.

7. The energy-saving circuit of claim 6, wherein the sixth to ninth electronic switches are n-channel FETs, the first to third terminals of the sixth to ninth electronic switches are corresponding to gates, sources, and drains of the FETs.

8. The energy-saving circuit of claim 6, wherein the audio circuit comprises an audio chip and fifteenth to twenty-second capacitors, a control pin of the audio chip is connected to the output terminal of the south bridge chip, first and second voltage pins of the audio chip are connected to a second end of the sixteenth resistor, third and fourth voltage pins of the audio chip are connected to the second terminal of the seventh electronic switch, a first input and output (I/O) pin of the audio chip is connected to a node between the fifth inductor and the seventh resistor through the fifteenth capacitor, a second I/O pin of the audio chip is connected to a node between the sixth inductor and the eighth resistor through the sixteenth capacitor, third and fourth I/O pins of the audio chip are respectively connected to the second terminal of the third and fourth resistors, a fifth I/O pin of the audio chip is connected to a node between the third inductor and the sixth resistor through the seventeenth capacitor, a sixth I/O pin of the audio chip is connected to a node between the fourth inductor and the fifth resistor through the eighteenth capacitor, a seventh I/O pin of the audio chip is connected to a node between the first inductor and the first resistor through the nineteenth capacitor, an eighth I/O pin of the audio chip is connected to the second inductor and the second resistor through the twentieth capacitor, first to fourth ground pins of the audio chip are grounded, a fifth ground pin of the audio chip is grounded through the twenty-first capacitor, the twenty-second capacitor is connected to the twenty-first capacitor in parallel.
